(19) United States
(12) Patent Application Publication
(10) Pub. No.: US 2012/0173709 A1
(43) Pub. Date: Jul. 5, 2012

(54) SEAMLESS SCALING OF ENTERPRISE APPLICATIONS

(76) Inventors: Li Li, Edison, NJ (US); Thomas Woo, Short Hills, NJ (US)

(21) Appl. No.: 12/984,938

(22) Filed: Jan. 5, 2011

(51) Int. Cl. G06F 9/50; G06F 15/16

(52) U.S. Cl. 709/224; 718/104

(57) ABSTRACT

Various exemplary embodiments relate to a method of scaling resources of a computing system, the method comprising. The method may include: setting a threshold value for a metric of system performance; determining an ideal resource load for at least one resource based on the threshold value for the metric; distributing a system work load among the computing system resources; and adjusting the number of resources based on the system work load, the ideal resource load, and a current number of resources. Various exemplary embodiments also relate to a computing system for scaling cloud resources. The computing system may include: internal resources; a load balancer; a performance monitor; a communication module; a job dispatching module; and a controller. Various exemplary embodiments also relate to a method of detecting dynamic bottlenecks during resource scaling using a resource performance metric and a method of detecting scaling choke points using historical system performance metric.

### TECHNICAL FIELD

Various exemplary embodiments disclosed herein relate generally to network extension.

### BACKGROUND

Cloud computing allows an entity to lease and use computer resources that are located anywhere on a network such as the Internet. Cloud resources can be leased from providers as needed and configured to perform a variety of services. Data may be sent to cloud resources using a Virtual Private Network (VPN) to ensure data security. Cloud providers may use virtual machines to offer customers a range in resource options. Cloud computing allows resource flexibility, agility and scalability.

One current cloud computing model is Amazon's virtual private cloud (VPC). VPC allows customers to lease computing resources as needed for an hourly rate. VPC uses a virtual machine model to abstract the actual computer resources into an elastic compute cloud (EC2). Customers may lease instances of virtual machines with the EC2. Customers can vary the number of virtual machines as their needs change. Amazon provides an API for managing the EC2 by monitoring, acquiring or releasing virtual machines.

Enterprises wishing to make use of a cloud computing system such as Amazon's VPC have several concerns. First, the security of a virtual machine is questionable. VPC customers are unaware of the exact configuration of cloud resources and may not want secure data processed on cloud resources. Second, because an enterprise must pay for the use of cloud resources, the enterprise may want to use internal computing resources of its own before acquiring cloud resources in a VPC. The enterprise must be able to efficiently control the scale of the cloud resources and the allocation of work between the cloud resources and the internal resources. Finally, additional computing resources do not necessarily solve all performance problems.

In view of the foregoing, it would be desirable to provide a system and method for controlling the scale of leased cloud resources. In particular, it would be desirable to provide a system that scales the cloud resources with respect to internal enterprise resources. Also, it would be desirable if the system optimized the use of cloud resources to prevent excessive costs.

### SUMMARY

In light of the present need for a system and method for controlling the scale of cloud resources, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of scaling resources of a computing system. The method may include: setting a threshold value for a first metric of system performance; distributing a system work load among the computing system resources; measuring the first metric of system performance based on the performance of the system during a previous time interval; comparing the measured first metric with the threshold value for the first metric; determining an ideal resource load for each resource based on the threshold value for the first metric; and adjusting the number of resources based on the system work load, the ideal resource load for each resource, and a current number of resources. Adjusting the number of computing system resources may include: determining an ideal number of resources by dividing the system work load by the ideal resource load for each resource; determining a change in resources by subtracting the current number of resources from the ideal number of resources; if the change in resources is negative, releasing at least one resource; and if the change in resources is positive, acquiring at least one additional resource. The method may also include determining that at least one system resource is operating in a bad region; refraining from acquiring additional system resources; and dropping service requests from the system work load. Various exemplary embodiments relate to the above method encoded on a machine-readable storage medium as instructions for scaling resources of a computing system.

Various exemplary embodiments relate to a computing system for scaling cloud resources. The computing system may include: internal resources that perform computing tasks; a load balancer; and a controller that scales cloud resources. The load balancer may include a performance monitor that collects system performance metrics including a first performance metric and a system load for a time interval; a communication module that collects cloud resource information including an amount of cloud resources, and a job dispatching module that directs computing tasks to the internal resources and the cloud resources. The controller may scale the cloud resources based on the first performance metric and provide cloud resource information to the load balancer. The controller may include: a scaling module that determines an ideal number of resources by dividing a predicted system load by a ideal resource load; and an instance manager that adjusts a total number of system resources to equal the ideal number of resources by acquiring or releasing cloud resources. Additionally, the performance monitor may measure an individual resource load and a performance metric for each resource and determine whether each resource is operating in a bad region by comparing the individual performance metric for the resource with a tolerable performance standard based on the individual resource load.

Various exemplary embodiments relate to a method of identifying a performance bottleneck in a computing system using internal resources and cloud resources. The method may include examining each resource; determining a tolerable value for a resource performance metric based on resource characteristics and resource load; measuring the resource performance metric; if the resource performance metric exceeds the tolerable value, determining that the resource is operating inefficiently; and if at least a predetermined number of the resources are operating inefficiently, determining that the system has reached a performance bottleneck.

Various exemplary embodiments relate to a method of identifying a scaling choke point in a computing system using cloud resources. The method may include: measuring a historical system metric value; estimating a system metric value gain for adding an additional resource based on the historical system metric value and a number of resources; adding the additional cloud resource; measuring an actual system metric value gain; and if the actual system metric value gain is less than a set percentage of the estimated system metric value gain, determining that the computing system has reached a performance bottleneck.

It should be apparent that, in this manner, various exemplary embodiments enable a system and method for optimized scaling of cloud resources. In particular, by measuring a performance metric and comparing the metric to a threshold, the method and system may use system feedback to scale cloud resources. Moreover, the method and system may also detect dynamic bottlenecks by determining when resources are operating at less-than-expected levels of efficiency.

### BRIEF DESCRIPTION OF THE DRAWINGS

In order to better understand various exemplary embodiments, reference is made to the accompanying drawings, wherein:

FIG. 1 illustrates a schematic diagram of an exemplary computing system for scaling cloud resources;

FIG. 2 illustrates an exemplary method of scaling cloud resources based on feedback;

FIG. 3 illustrates an exemplary method of adjusting the number of cloud resources;

FIG. 4 illustrates an exemplary method of determining a change in the ideal number of cloud resources;

FIG. 5 illustrates a graph showing exemplary response time of a resource;

FIG. 6 illustrates a graph showing exemplary ideal load of a resource; and

FIG. 7 illustrates a graph showing exemplary operating regions of a resource.

### DETAILED DESCRIPTION

Referring now to the drawings, in which like numerals refer to like components or steps, there are disclosed broad aspects of various exemplary embodiments.

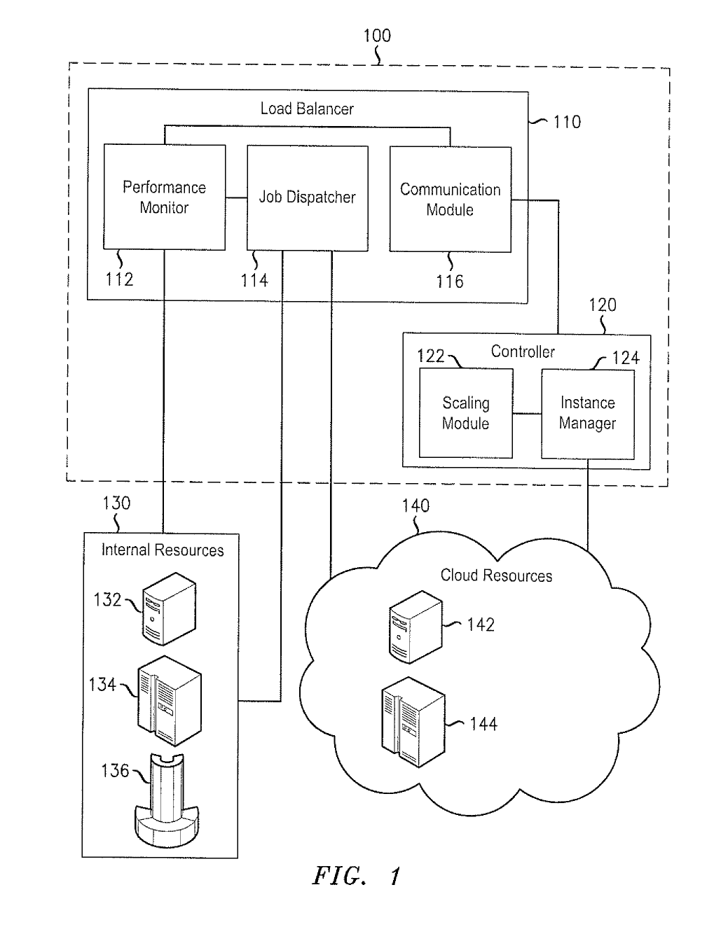

FIG. 1 illustrates a schematic diagram of an exemplary computing system 100 for scaling cloud resources 140. System 100 may include load balancer 110 and controller 120. System 100 may be connected to internal resources 130 and cloud resources 140. System 100 may receive service requests and distribute the requests for processing to either internal resources 130 or cloud resources 140. Service requests may vary depending on the services offered by the system proprietor. For example, the system proprietor may offer content such as text, images, audio, video, and gaming, or services such as sales, computation, and storage, or any other content or service offered on the Internet. Service requests may also include enterprise applications where requests may arrive from an internal enterprise network. The service requests may be considered the system work load. The system work load may be measured by the arrival rate of service requests. System 100 may also scale cloud resources 140 to efficiently manage the service request load.

Load balancer 110 may receive service requests from users located anywhere on the Internet. Load balancer 110 may distribute service requests to either internal resources 130 or cloud resources 140. Load balancer 110 may also receive completed service requests to return to the requesting user. The distribution of service requests may depend on the performance of the various resources. Load balancer 110 may monitor the total system performance as well as the performance of individual internal resources 130 and external resources 140. Load balancer 110 may provide performance data to controller 120 to help determine whether scaling of cloud resources 130 is necessary. Load balancer 110 may receive configuration and performance information about cloud resources 140 from controller 120. Load balancer 110 may include performance monitor 112, job dispatcher 114, and communication module 116.

Performance monitor 112 may include hardware and/or executable instructions on a machine-readable storage medium configured to monitor the performance of the system as a whole in processing service requests. Performance monitor 112 may use a metric to evaluate whether the system is performing adequately. In various exemplary embodiments, performance monitor 112 may calculate a system response time, from arrival of a service request at the load balancer 110 to return of a response at the load balancer 110, as a metric for measuring system performance. For example, the performance monitor may measure a certain percentile of service request response time such as, for example, the response time of service requests falling in the 95^{th} percentile, to provide a metric of system performance. Performance monitor 112 may be configured with a threshold value for a metric to indicate that performance is inadequate when the threshold is crossed. Performance monitor 112 may also measure other metrics that may be appropriate for measuring system performance. Performance monitor 112 may also collect measurements from other components such as, for example, internal resources 130, communication module 116 and controller 120.

Job dispatcher 114 may include hardware and/or executable instructions on a machine-readable storage medium configured to distribute incoming service requests among internal resources 130 and cloud resources 140. As will be described in more detail below, internal resources 130 may include several types of resources, including private resources. Likewise cloud resources 140 may include different types of resources. Job dispatcher 114 may distribute service requests to the appropriate type of resource to handle the request. Job dispatcher 114 may also balance the request load among resources of the same type. Job dispatcher 114 may use a policy to determine the allocation of requests between internal resources 130 and cloud resources 140. For example, a policy seeking to save costs may prefer internal resources to cloud resources as long as a performance metric remains below a threshold. An alternative example policy may seek to optimize a metric by allocating requests to the resource best able to handle the request. Methods known in the art for load balancing such as, for example, weighted round robin, least connections, or fastest response may be used by a policy to balance the request load.

Communication module 116 may include hardware and/or executable instructions on a machine-readable storage medium configured to interact with controller 120 to scale cloud resources. Communication module 116 may provide performance metrics from performance monitor 112 to controller 120. Communication module 116 may be configured with callback functions that report metrics if they exceed a threshold. Controller 120 may send communication module 116 performance metrics for cloud resources 140 for collection at performance monitor 112. Communication module 116 may also receive cloud resource information from controller 120 such as, for example, the number and characteristics of machines or virtual machines used as cloud resources. Communications module 116 may pass this cloud resource information to performance monitor 112 and job dispatcher 114 to allow effective performance measurement and request distribution. In various alternative embodiments, controller 120 may be integrated with load balancer 110, in which case communication module 116 may not be necessary.

Controller 120 may control cloud resources 140. Controller 120 may be a binary feedback controller, proportional controller (P controller), proportional-integral controller (PI controller), or proportional-integral-derivative controller (PID controller). Controller 120 may determine an appropriate scale of cloud resources 140 based on information received from communication module 116 and from cloud resources 140. Controller 120 may release or acquire cloud resources by sending appropriate requests to cloud resources 140. Controller 120 may include scaling module 122 and instance manager 124.

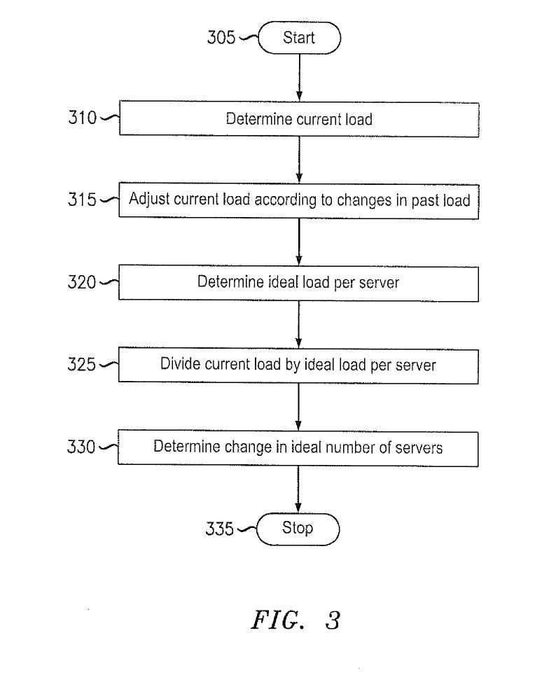

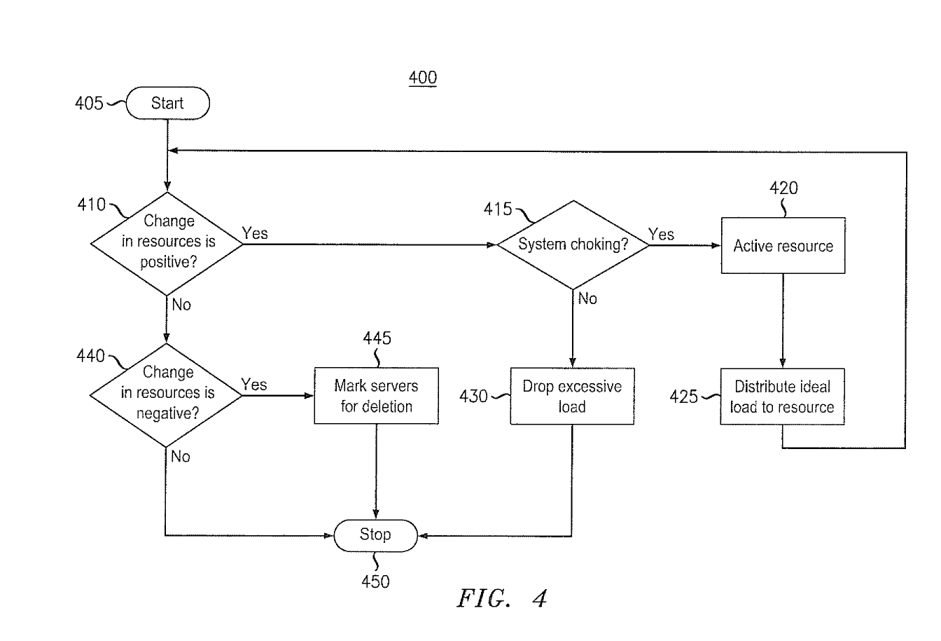

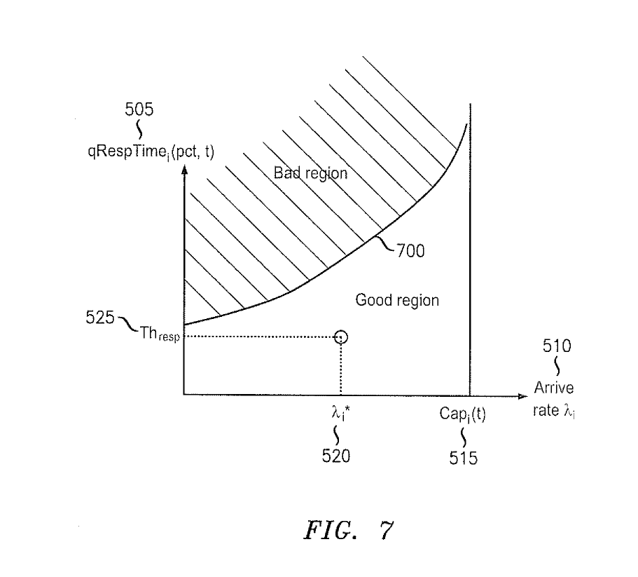

Scaling module 122 may include hardware and/or executable instructions on a machine-readable storage medium configured to determine an appropriate number of cloud resources 140 based on performance metrics provided by performance monitor 112. Scaling module 122 may determine an appropriate number of cloud resources and pass the number to instance manager 124. Scaling module 122 may use performance metrics and other data provided by performance monitor 112 to determine the number of cloud resources to be utilized. As will be described below regarding FIGS. 4 and 7, scaling module 122 may also determine whether the system is choking. System 100 may choke if the system faces a dynamic bottleneck other than the scale of cloud resources. For example, a large number of requests may use so much bandwidth that network constraints may limit the ability to scale service requests to the cloud resources. Scaling module 122 may use information from performance monitor 112 and cloud resources 140 to determine that there is a dynamic bottleneck if performance data indicates that at least one resource is operating in a bad region. Exemplary methods used by scaling module 122 will be described in further detail below regarding FIG. 3.

Instance manager 124 may include hardware and/or executable instructions on a machine-readable storage medium configured to control cloud resources 140 to implement the scale indicated by scaling module 124. In various exemplary embodiments, cloud resources 140 are provided with an application programming interface (API) that allows instance manager 124 to acquire additional resources or release unneeded resources. Instance manager 124 may track each resource currently leased and be aware of when the lease will end. Instance manager 124 may mark resources for release if there are more resources than indicated by scaling module 122. Instance manager 124 may decide whether and when to acquire a new lease to implement the number of cloud resources indicated by scaling module 122. Instance manager 124 may reactivate resources marked for deletion rather than acquire a new resource. Instance manager 124 may also obtain cloud resource information from cloud resources 140 using the API and pass the information to scaling module 122 and communication module 116. In various alternative embodiments, cloud resources 140 may include an auto-scaler and load manager. In these embodiments, instance manager 140 may configure the cloud resources 140 auto-scaler or enable/disable the auto-scaler to achieve the desired number of cloud resources. In various alternative embodiments, system 100 may interact with different providers of cloud resources. In these embodiments, there may be more than one instance manager 124 to control the different cloud resources 140.

Internal resources 130 may include computer resources owned and operated by the system proprietor. Internal resources 130 may perform various computing tasks such as fulfilling service requests. Internal resources 130 may be divided into multiple tiers. For example, a three tier system may include front-end servers 132 that communicate with users, application servers 134 which implement business logic, and database servers 136. In various exemplary embodiments, one or more tiers may be private. For example, database servers 136 may be private because they contain sensitive private information which, by law, a proprietor may not share. It also may be expensive and time consuming to instantiate a database server as a cloud resource. Load balancer 110 may avoid duplicating requests for private resources as cloud requests. Load balancer 110 may always allocate certain service requests to internal resources 130 if the request requires access to private resources.

Cloud resources 140 may be computer resources owned by a cloud resource provider and leased to system proprietors. In various exemplary embodiments, cloud resources are organized as virtual machines. A system proprietor may lease a virtual machine to emulate an internal resource. For example, cloud server 142 may emulate front-end server 132, and cloud server 144 may emulate application server 134. Although a cloud resource provider may actually implement the virtual machine differently, the provider may guarantee the same performance as the emulated internal resource. System 100 may treat cloud resources 140 as identical to corresponding internal resources 130. System 100 may also recognize that cloud resources 140 may have a longer response time than internal resources 130 due to communications delay. Cloud resources may be leased as needed, but may require substantial start up time as a virtual machine is instantiated. Cloud resource providers may lease cloud resources based on an hourly rate, actual usage, or any other billing method.

Having described the components of system 100, a brief explanation of the operation of an exemplary embodiment will be described. The process may begin in a relatively non-busy state in which the internal resources 130 are capable of processing all service requests. In this state, load balancer 110 may distribute all requests between internal resources 130. As the rate of service requests increases, system performance may degrade, and performance monitor 112 may detect that a performance metric has exceeded a threshold. Communication module 116 may then inform controller 120 that the performance metric has exceeded the threshold and provide other system information. Scaling module 122 may then determine how many cloud resources are required to meet the performance metric threshold. Instance manager 124 may then communicate with cloud resources 140 to acquire additional resources, such as, for example, cloud server 142. Once each cloud resource 140 is operational, instance manager 124 may inform communication module that the resource is available. Job dispatcher 114 may then assign service requests to both the internal resource 130 and the cloud resources 140. Scaling module 122 may continue to determine how many cloud resources are required, and instance manager 124 may add or release resources as necessary. Scaling module 122 may also determine whether the system 100 is choking before adding additional resources. In this manner, system 100 may scale the cloud resources to achieve a desired performance metric.

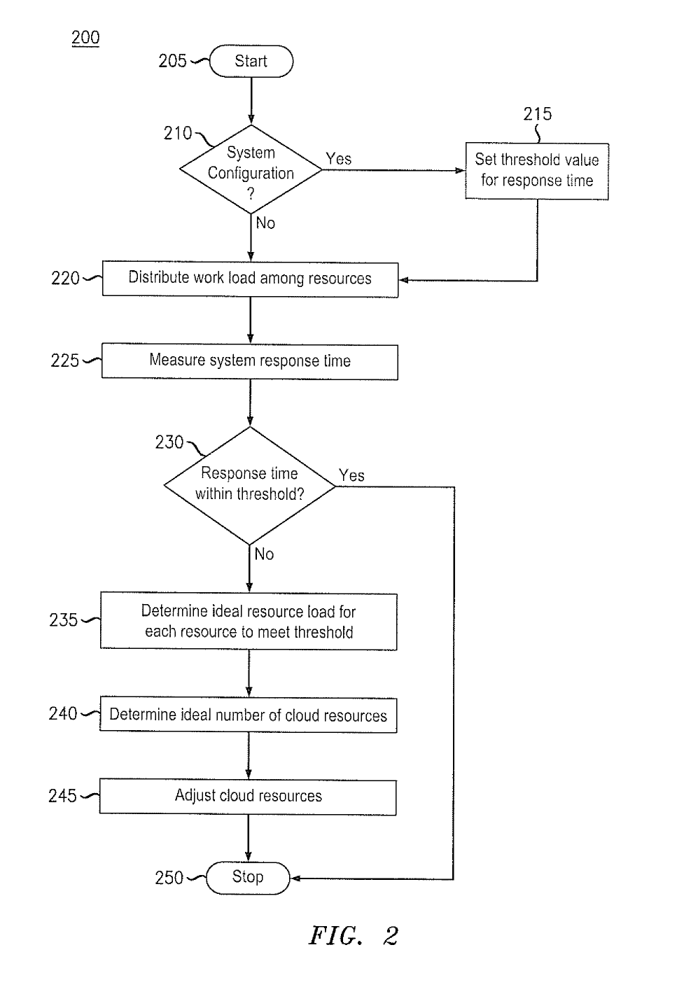

FIG. 2 illustrates a flowchart for an exemplary method 200 of scaling cloud resources 140 based on feedback. The method 200 may be performed by the components of system 100. System 100 may perform method 200 repeatedly in order to continually adjust the number of cloud resources 140. System 100 may perform method 200 during a fixed time interval. In various exemplary embodiments, the time interval may be 10 seconds, but any time interval may be chosen.

The method 200 may begin in step 205 and proceed to step 210, where system 100 may determine whether to configure system 100. If the method 200 is being performed for the first time, system 100 may decide to perform configuration and the method may proceed to step 215. If the system 100 has already been configured, the method may proceed to step 220.

In step 215, system 100 may set various threshold values. For example performance monitor 112 may set a threshold value for the system response time. This metric may represent a performance goal for handling service requests. Performance monitor 112 may also be configured with the time interval for measuring system performance. System 100 may also perform other configuration tasks. For example instance manager 124 may determine which virtual machines on among cloud resources 140 to use to emulate each internal resource 130. Job dispatcher 114 may be initialized with the number of internal resources 130 that may be used to process service requests. The method 200 may then proceed to step 220.

In step 220, job dispatcher 114 may distribute incoming service requests among internal resources 130 and cloud resources 140. The job dispatcher 114 may implement a policy for distributing service requests. For example, job dispatcher 114 may prefer internal resources 130 as long as the response time does not exceed a performance threshold. This policy may minimize the use and costs of cloud resources 140. The internal resources 130 and the cloud resources 140 may then process the service requests. Completed service request responses may be returned through load balancer 110. The method may then proceed to step 225.

In step 225, performance monitor 112 may measure a system performance metric such as, for example, the system response time. In various embodiments, a measurement of the 95th percentile of the individual service request response times may be used as an effective measurement of system performance. Performance monitor 112 may also measure the system service request load. Other percentiles or performance metrics may also be used. The method may then proceed to step 230.

In step 230, the performance metric may be compared with the threshold value configured in step 215. If the measured system metric exceeds the threshold value, the method 200 may proceed to step 235. If the measured system metric does not exceed the threshold value, system 100 may determine that no adjustment of resources is necessary, and the method may proceed to step 245 where the method ends.

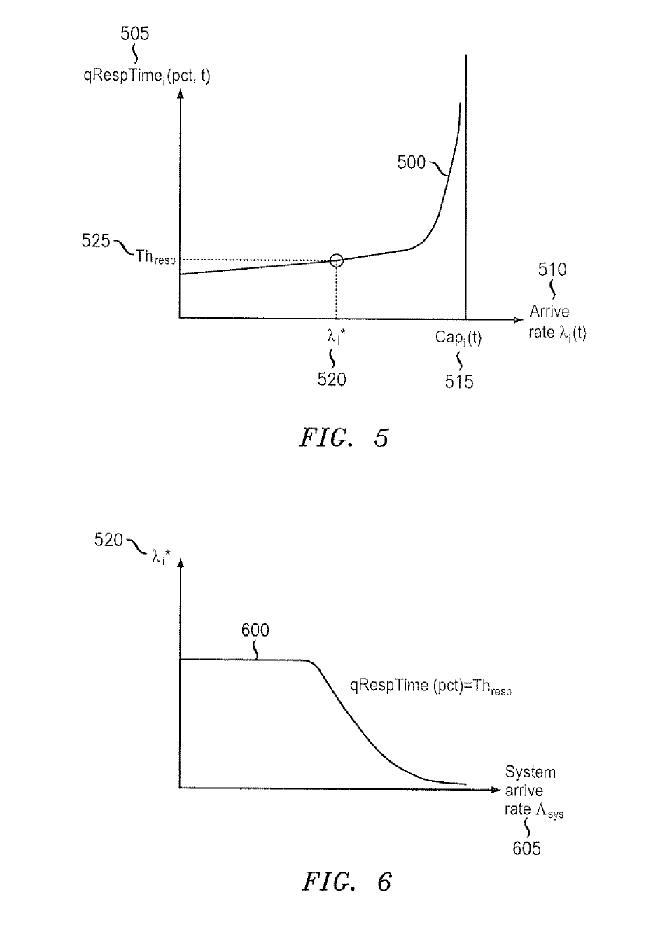

In step 235, scaling module 122 may determine the ideal resource load for each resource to meet the performance threshold. As a will be described in further detail regarding FIG. 5 and FIG. 6, the ideal request load for each resource may vary depending on resource characteristics and system load. The ideal request load for each resource of the same type may be the same. For example, each front-end server 132 may have the same ideal request load. Likewise, each cloud server 142 that emulates front end server 132 may have the same ideal request load. The method 200 may then proceed to step 240.

In step 240, scaling module 122 may determine the correct number of cloud resources. In a various exemplary embodiments where controller 120 is a binary feedback controller, scaling module 122 may simply add a set number of additional cloud resources if the measured performance metric exceeded the threshold value as determined in step 230. Alternatively, scaling module 122 may multiply the number of cloud resources 140 for a faster increase in system performance. In various exemplary embodiments where controller 120 is a P controller, scaling module 122 may determine the correct number of cloud resources 140 by dividing the measured system load by the ideal resource load as determined in step 235. In these embodiments, the change in cloud resources may be proportional to the fraction of system load exceeding performance. In the various exemplary embodiments were controller 120 is a PI controller, scaling module 122 may determine the correct number of cloud resources 140 by adding an integral component to the measured system load before dividing by the ideal resource load. The integral component may be a summation of the changes in the system load over a set time interval. Scaling module 122 may also use a derivative component in various embodiments wherein controller 120 is a PID controller. The operation of scaling module 122 will be described in further detail below regarding FIG. 3. The method 200 may then proceed to step 245.

In step 245, instance manager 124 may adjust cloud resources in accordance with the number of cloud resources 140 determined in step 240. Instance manager 124 may communicate with a cloud resource provider to add additional cloud resources 140. In various embodiments, instance manager 124 may further use performance monitor 112 to determine whether system 100 is choking before adding any additional cloud resources 140. Instance manager 124 may also mark cloud resources 140 for release. The operation of instance manager 124 will be described in further detail below regarding FIG. 3. Once instance manager 124 has adjusted the number of resources, the method 200 may proceed to step 250 where the method ends.

FIG. 3 illustrates a flowchart for an exemplary method 300 of determining a change in the ideal number of cloud resources. Method 300 may describe the operation of system 100 during step 240 of method 200.

Method 300 may begin at step 305 and proceed to step 310, where performance monitor 112 may determine the current system load. The current system load may be measured as the arrival rate of the service requests during a previous time interval. The current system load may include both the service requests processed by internal resources 130 and cloud resources 140. Alternatively, the load for internal resources 130 may be subtracted because internal resources 130 are fixed. Performance monitor 112 may send the current system load to scaling module 122 via communication module 116. The method may then proceed to step 315.

In step 315, scaling module 122 may adjust the current load according to an integral component. The integral component may be a summation of the changes in system load over previous time intervals. The integral component may help indicate a trend in system load. The integral component may also include a weighting factor. In various exemplary embodiments such as those where controller 120 is a P controller, step 315 may be optional. In various alternative embodiments, step 315 may also include adjusting the current load according to a derivative component. The method may then proceed to step 320.

In step 320, scaling module 122 may determine an ideal load for each server. As will be described below regarding FIGS. 5 and 6, the ideal load per resource may be the maximum load that the resource can handle while remaining within the system performance metric threshold. The ideal load per resource may be the same for each resource of the same type, including both internal resources 130 and cloud resources 140. The method may then proceed to step 325.

In step 325, scaling module 122 may divide the current load by the ideal load per resource. The result may indicate the number of resources required to handle the expected incoming request load. The method may then proceed to step 330, where scaling module 122 may determine the required change in the number of cloud resources. Scaling module 122 may subtract the number of internal resources 130 and the current number of cloud resources 140 from the required number of resources. Alternatively, if the load on internal resources was already subtracted, scaling module 122 may only subtract the current number of cloud resources. Scaling module 122 may pass the change in cloud resources to instance manager 124. The method 300 may then proceed to step 335, where the method ends.

FIG. 4 illustrates a flowchart for an exemplary method 400 for adjusting the number of cloud resources. Method 400 may describe the operation of system 100 during step 245 of method 200. Method 400 may begin in step 405 and proceed to step 410, instance where manager 124 may determine whether the change in cloud resources is positive. If the change in cloud resources is positive, method 400 may proceed to step 415. If the change in cloud resources is negative, method 400 may proceed to step 440.

In step 415, instance manager 124 may use performance monitor 112 to determine whether the system is choking before adding an additional cloud resource. As will be described in further detail below regarding FIG. 7, performance monitor 112 may determine that an individual resource is operating in a bad region if a system performance metric for that resource is greater than an expected value given the system inputs. This disparity in performance metric may indicate that the resource is operating inefficiently. If performance monitor 112 determines that at least one resource is operating in a bad region, it may determine that the system is choking. Alternatively, performance monitor 112 may require a set percentage of the resources to be operating in a bad region before determining that the system is choking. In various alternative embodiments, performance monitor 112 may determine whether the system is choking by measuring the throughput gain of an additional resource. Performance monitor 112 may compare the measured throughput gain with an estimated gain based on a historical maximum throughput per resource. If the measured throughput gain is less than a set percentage of the estimated throughput gain, performance monitor 112 may determine that the system is choking. In these alternative embodiments, performance monitor 112 may determine that the system is no longer choking when the measured throughput approaches an estimated throughput based on the historical maximum throughput per resource. If performance monitor 112 determines that the system is not choking, the method 400 may proceed to step 420. If performance monitor 112 determines that the system is choking, the method 400 may proceed to step 430.

In step 420, instance manager 124 may activate an additional cloud resource 140. If any existing cloud resources 140 are marked for release, instance manager 124 may activate the cloud resource 140 by unmarking it. If there are no cloud resources 140 marked for release, instance manager 124 may communicate with a cloud resource provider to instantiate an additional cloud resource 140. Instance manager 124 may also subtract one from the change in cloud resources. The method of 400 may then proceed to step 425.

In step 425, instance manager 124 may indicate to load balancer 110 that an additional cloud resource has been added. Performance monitor 110 may begin monitoring the new cloud resource. Job dispatcher 114 may distribute service requests to the new cloud resource. The method 400 may then return to step 410 to determine whether to add additional cloud resources.

In step 430, load balancer 110 may drop excessive service requests to prevent the system from choking. Because the system 100 has determined that additional cloud resources 140 may not improve the system performance metric, load balancer 110 may reduce the service request load on the existing resources. Performance monitor 112 may also determine what type of dynamic bottleneck is causing the system 100 to choke. For example, if performance monitor 112 determines that the performance metric for a private resource such as database servers 136 exceeds a threshold, performance monitor 112 may determine that the private resource is causing a dynamic bottleneck. As another example, if performance monitor 112 detects that the response time for cloud resources 140 is much greater than the response time for internal resources 130, performance monitor 112 may determine that network congestion is causing a dynamic bottleneck. Performance monitor 112 may report the dynamic bottleneck to a system administrator. The method 400 may then proceed to step 450 where the method ends.

In step 440, instance manager 124 may determine whether the change in cloud resources 140 is negative. If the change in cloud resources 140 is negative, the method 400 may proceed to step 445. If the change in cloud resources 140 is not negative, instance manager 124 may do nothing. The method 400 may then proceed to step 450 where the method ends.

In step 445, instance manager 124 may mark cloud resources 140 for release. Instance manager 124 may choose individual cloud resources 140 that are approaching the end of their lease and are likely to complete assigned service requests. Instance manager 124 may release marked cloud resources when their lease expires. The method 400 may then proceed to step 450 where the method ends.

FIG. 5 illustrates a graph 500 showing exemplary response time of a resource. The graph 500 shows that the response time 505 of the resource increases as the arrival rate 510 of the service requests increases. At some point, Capᵢ(t) 515, it becomes impossible for the resource to handle the arrival rate of service requests. As the arrival rate approaches Capᵢ(t) 515, the response time 505 increases dramatically. The graph 500 also shows how an ideal resource request load, λᵢ* 520, can be predicted to meet a given threshold response time, Thᵣₑₛₚ 525.

FIG. 6 illustrates a graph 600 showing exemplary ideal load of a resource. As the system arrival rate, Λ_{sys} 605, increases beyond a certain point, the ideal resource request load, λᵢ* 520, decreases. This effect may be explained by the overhead required by system 100 to distribute a large number of service requests. Dynamic bottlenecks such as non-scalable private resources or network congestion may add to the response time, making it harder for individual resources to respond within the threshold response time. Therefore, the ideal resource request load, λᵢ* 520, decreases to allow resources to meet the threshold.

FIG. 7 illustrates a graph 700 showing exemplary operating regions of a resource. The graph 700 may indicate a tolerable response rate given system inputs such as, for example, actual individual resource request load, λᵢ 510, and system arrival rate, Λ_{sys} 605. If the response time is below the graph 700, the resource may be operating in a good region, indicating that the resource is performing efficiently. For example, if the resource is operating at the ideal resource request load, λᵢ* 520, and has a response time equal to the threshold response time, Thᵣₑₛₚ 525, the resource may be operating in the middle of the good region. On the other hand, if the response rate is above the graph 700, or the actual individual resource request load, λᵢ 510, is greater than Capᵢ(t) 515, the resource may be operating in a bad region or be performing inefficiently. Each type of resource may be provided with a representation of graph 700 such as, for example, a function or a list of critical points. Alternatively, graph 700 may be determined by performance monitor 112 based on test data. Cloud resources 140 that emulate internal resources 130 may be assigned the same graph 700 as the resource they emulate. It should be apparent that operating regions may be determined using a metric other than response time. For other metrics such as, for example, resource throughput, a higher metric value may be desirable and the graph may vary accordingly.

According to the foregoing, various exemplary embodiments provide for a system and method for scaling cloud resources. In particular, by measuring a performance metric and comparing the metric to a threshold, the method and system implement a feedback controller for scaling cloud resources. Furthermore, by adjusting the cloud resources based on the system load and an ideal resource load, the adjustment is proportional to the fraction of the load exceeding performance. Moreover, the method and system may also detect dynamic bottlenecks by determining when resources are operating in a bad region.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of scaling resources of a computing system, the method comprising:
setting a threshold value for a first metric of system performance;
determining at least one ideal resource load for at least one resource based on the threshold value for the first metric;
distributing a system work load among the computing system resources; and
adjusting the number of resources based on the system work load, the ideal resource load, and a current number of resources.

2. The method of claim 1, wherein the step of adjusting the number of computing system resources comprises:
determining an ideal number of resources by dividing the system work load by the ideal resource load;
determining a change in resources by subtracting the current number of resources from the ideal number of resources;
if the change in resources is negative, releasing at least one resource; and
if the change in resources is positive, acquiring at least one additional resource.

3. The method of claim 2, wherein the step of releasing at least one resource comprises:
marking at least one resource for release;
refraining from distributing work to the resource marked for release; and
releasing a resource when a lease of the resource expires.

4. The method of claim 2, wherein the step of acquiring at least one additional resource comprises:
determining whether there is at least one resource marked for release;
if there is at least one resource marked for release, unmarking the at least one resource and distributing work to the at least one resource; and
if there is not at least one resource marked for release, acquiring an additional resource.

5. The method of claim 1, wherein the resources of the computing system include both internal resources and cloud resources and the step of adjusting the number of resources comprises adjusting the number of cloud resources.

6. The method of claim 5, wherein the internal resources include private resources and the step of distributing the system work load comprises distributing requests involving private resources only to internal resources.

7. The method of claim 1, further comprising:
determining that at least one system resource is operating in a bad region;
refraining from acquiring additional system resources; and
dropping service requests from the system work load.

8. The method of claim 7, wherein the step of determining that at least one system resource is operating in a bad region comprises:
for each resource:
determining a first performance metric for the resource;
determining an actual work load for the resource;
comparing the performance metric with a tolerable performance standard based on the actual work load and system work load; and
determining that the resource is operating in a bad region if the first performance metric exceeds the tolerable performance standard.

9. The method of claim 1, wherein the first metric of system performance is a response time for a set percentile of all service requests received by the computing system.

10. The method of claim 1, wherein the step of adjusting the number of computing system resources comprises:
determining an ideal number of resources by dividing a sum of the system work load and an integral component by the ideal resource load for each resource;
determining a change in resources by subtracting the current number of resources from the ideal number of resources.

11. The method of claim 10, wherein the integral component is the summation of the changes in system work load over a second previous time interval.

12. A computing system for scaling cloud resources comprising:
internal resources that perform computing tasks;
a load balancer comprising:
a performance monitor that collects system performance metrics including a first performance metric and a system load for a time interval;
a communication module that collects cloud resource information including an amount of cloud resources, and
a job dispatching module that directs computing tasks to the internal resources and the cloud resources; and
a controller that scales the cloud resources based on the first performance metric and provides cloud resource information to the load balancer.

13. The system of claim 12, wherein the controller adjusts the amount of cloud resources if the first performance metric exceeds a threshold.

14. The system of claim 12, wherein the internal resources comprise private resources and the job dispatching module directs computing tasks involving private resources only to the internal resources.

15. The system of claim 12, wherein the controller further comprises:
a scaling module that determines an ideal number of resources by dividing a predicted system load by a ideal resource load; and
an instance manager that adjusts a total number of system resources to equal the ideal number of resources by acquiring or releasing cloud resources.

16. The system of claim 15, wherein the predicted system load is the system load for a previous time interval.

17. The system of claim 15, wherein the predicted system load is the system load for the previous time interval adjusted by an integral component comprising a summation of the changes in system work load over at least two previous time intervals.

18. The system of claim 12, wherein the performance monitor measures an individual resource load and a performance metric for each resource and determines whether each resource is operating in a bad region by comparing the individual performance metric for the resource with a tolerable performance standard based on the individual resource load.

19. The system of claim 18, wherein the controller refrains from acquiring additional cloud resources if at least one resource is operating in a bad region.

20. A machine-readable storage medium encoded with instructions for scaling resources of a computing system, the machine-readable storage medium comprising:
instructions for setting a threshold value for a first metric of system performance; instructions for determining an ideal resource load for each resource based on the threshold value for the first metric;
instructions for distributing a system work load among the computing system resources; and
instructions for adjusting the number of resources based on the system work load, the ideal resource load, and a current number of resources.

21. The machine-readable storage medium of claim 20, wherein the instructions for adjusting the number of computing system resources comprise:
instructions for determining an ideal number of resources by dividing the system work load by the ideal resource load;
instructions for determining a change in resources by subtracting the current number of resources from the ideal number of resources;
instructions for releasing at least one resource if the change in resources is negative; and
instructions for acquiring at least one additional resource if the change in resources is positive.

22. The machine-readable storage medium of claim 21, wherein the instructions for releasing at least one resource if the change in resources is negative comprise:
instructions for marking at least one resource for release;
instructions for refraining from distributing work to the resource marked for release; and
instructions for releasing a resource when a lease of the resource expires.

23. The machine-readable storage medium of claim 21, wherein the instructions for acquiring at least one additional resource comprise:
instructions for determining whether there is at least one resource marked for release;
instructions for unmarking the at least one resource and distributing work to the at least one resource if there is at least one resource marked for release; and
instructions for acquiring an additional resource if there is not at least one resource marked for release.

24. The machine-readable storage medium of claim 20, wherein the resources of the computing system include both internal resources and cloud resources and the instructions for adjusting the number of resources comprise instructions for adjusting the number of cloud resources.

25. The machine-readable storage medium of claim 24, wherein the internal resources include private resources and the instructions for distributing the system work load comprise instructions for distributing requests involving private resources only to internal resources.

26. The machine-readable storage medium of claim 20, further comprising:
instructions for determining that at least one system resource is operating in a bad region;
instructions for refraining from acquiring additional system resources; and
instructions for dropping service requests from the system work load.

27. The machine-readable storage medium of claim 26, wherein the instructions for determining that at least one system resource is operating in a bad region comprise:
instructions for determining for each resource:
a first performance metric for the resource, and
an actual work load for the resource;
instructions for comparing the performance metric with a tolerable performance standard based on the actual work load and system work load; and
instructions for determining that the resource is operating in a bad region if the first performance metric exceeds the tolerable performance standard.

28. The machine-readable storage medium of claim 20, wherein the first metric of system performance is a response time for a set percentile of all service requests received by the computing system.

29. The machine-readable storage medium of claim 20, wherein the instructions for adjusting the number of computing system resources comprise:
instructions for determining an ideal number of resources by dividing a sum of the system work load and an integral component by the ideal resource load for each resource;
instructions for determining a change in resources by subtracting the current number of resources from the ideal number of resources.

30. The machine-readable storage medium of claim 29, wherein the integral component is the summation of the changes in system work load over a second previous time interval.

31. A method of identifying a performance bottleneck in a computing system using internal resources and cloud resources, the method comprising:
for each resource:
determining a tolerable value for a resource performance metric based on resource characteristics and resource load;
measuring the resource performance metric;
if the resource performance metric exceeds the tolerable value, determining that the resource is operating inefficiently; and
if at least a predetermined number of the resources are operating inefficiently, determining that the system has reached a performance bottleneck.

32. The method of claim 31, wherein the system performance metric is a response time.

33. The method of claim 31, further comprising determining the predetermined number of resources based on a proportion of a total number of resources.

34. The method of claim 31, further comprising: refraining from acquiring additional cloud resources.

35. The method of claim 31, further comprising: dropping service requests from a system work load.

36. The method of claim 31, further comprising: identifying a type of performance bottleneck based on a type of a resource that is operating inefficiently.

37. A method of identifying a scaling choke point in a computing system using cloud resources, the method comprising:
measuring a historical system metric value;
estimating a system metric value gain for adding an additional resource based on the historical system metric value and a number of resources;
adding the additional cloud resource;
measuring an actual system metric value gain;
if the actual system metric value gain is less than a set percentage of the estimated system metric value gain, determining that the computing system has reached a performance bottleneck.

38. The method of claim 37, wherein the system metric is a system throughput rate.

39. The method of claim 37, further comprising refraining from acquiring additional cloud resources.

40. The method of claim 39, further comprising resuming acquisition of additional cloud resources when the measured system metric approaches an estimated system metric value based on the historical system metric.

41. The method of claim 37, further comprising: dropping service requests from a system work load.

42. The method of claim 37, further comprising: identifying a type of performance bottleneck based on a type of the additional resource.
